(19) United States
(12) Patent Application Publication
(10) Pub. No.: US 2003/0007583 A1
(43) Pub. Date: Jan. 9, 2003

(54) Correction of multiple transmission impairments

(76) Inventors: Howard E. Hilton, Snohomish, WA (US); Gerald J. Ringel, Marysville, WA (US)

Correspondence Address: AGILENT TECHNOLOGIES, INC., Legal Department, 51U-PD, Intellectual Property Administration, P.O. Box 58043, Santa Clara, CA, 95052-8043, US

(21) Appl. No.: 09/846,138

(22) Filed: Apr. 30, 2001

(51) Int. Cl. H04B 1/10; G06F 17/10

(52) U.S. Cl. 375/350; 375/229; 708/300

(57) ABSTRACT

In generating, transmitting, and receiving data signals, various forms of complex modulation formats are often used and the signals are most often processed as two component (I, Q) signals. Such modulated signals are subject to a variety of impairments due to imperfections in the various elements in the transmission chain. For the large class of essentially linear impairment processes, the impairments may be removed with compensating filters, one filter being assigned to each impairment. In this invention, the generalized filter, a new class of two-channel filters for compensating impairments, is disclosed. Compared with previous two-channel filters, which are characterized by two impulse responses, the generalized filter is characterized by four such impulse responses. This filter can simultaneously compensate a plurality of diverse impairments. A process for characterizing and designing a generalized filter is disclosed, along with a technique for efficiently computing the response of the filter to an arbitrary input sequence.

### FIELD OF THE INVENTION

This invention relates to the transmission of information in analog form and, specifically, to the combined and simultaneous correction, using digital techniques, of a plurality of impairments of such information.

### BACKGROUND OF THE INVENTION

The generation, transmission, and reception of information often requires the use of complex methods of representing the information. This is especially true when the information is digital data that is transported as modulation on a carrier. In this case, signals with very complex modulation formats are often used in order to conserve spectral space by “packing” more data into a given bandwidth.

In general, the more complex the modulation format used, the more the signal is subject to various forms of impairment imposed on it by defects in various elements of the signal transport chain. Among these defective elements causing impairments are misaligned filters, multipath transmission, quadrature errors in in phase (I) and quadrature (Q) processing channels, and nonidentical I and Q channels.

The existence of such impairments to the signal causes increased data errors or, alternatively, more effort for error detection and correction.

Although some impairments—such as signal compression—are nonlinear and often result in irreversible damage to the signal, many common impairments can be regarded as linear operations on the signal. The number of potential impairments is increased by the fact that data signals are usually processed in dual (I and Q) channels; that is, as two-component signals. Linear impairments can, in principle, be removed by additional linear operations which undo the impairment. The linear operators can be regarded as two-channel filters whose characteristics are inverse to those of the impairments. In general, if there are two known impairments, the cure is two filters in cascade, each adjusted to compensate for one impairment. Three impairments would require three filters, and so on. A single two-channel filter for dealing with all the linear impairments simultaneously has not appeared, although it would simplify both hardware and software filtering and reduce signal latency.

### SUMMARY OF THE INVENTION

The embodiment of the invention disclosed herein concerns the use of a novel form of two-channel filter, referred to in this disclosure as a generalized filter for two-component signals. Heretofore, the concept of two-channel filters has referred to a) a way to combine the description of two independent filters, one for each part of a two-component signal, such as the I and Q channels in signal processing; or b) a filter whose impulse response is complex (hᵣ+jhᵢ), requiring a separate channel for each component of the response. Both types of filters have been used in the prior art for compensating the effects of certain impairments on signals. In these filters, two independent descriptions (or degrees of freedom) are required to characterize the filter for computing its response to an arbitrary signal. The embodiment disclosed herein concerns the use of a generalized filter for correcting several types of impairments that can occur in receivers for data-modulated signals. However, the inventive principles are equally applicable to generators of data-modulated signals, which would include elements such as dual data channels, quadrature mixers (that is, up-converting modulators), and IF filters, all used in the process of converting baseband data into a modulated RF signal.

In this disclosure, several signal impairments are identified and an appropriate filter characteristic for compensating for the effect of the impairment is determined for each. Then, contrasted with prior methods, these characteristics are combined, with a view to dealing with all the impairments simultaneously in a single filter. Such a generalized filter must be characterized by four independent descriptions or degrees of freedom. If I and Q are the two components of an input signal, there are four impulse responses associated with this filter: direct terms in I-I and Q-Q, and cross-channel terms in I-Q and Q-I.

Two significant features of the embodiment of the invention disclosed herein are a) a method for determining the characteristics of a generalized filter which will compensate for a plurality of different signal impairments, and b) a method for efficiently computing the output of a digital embodiment of such a filter. The latter uses a FFT-based procedure and is analogous to the well-known procedure used for simpler one- or two degree-of-freedom filters, although there is no obvious extension of that procedure to the generalized filter case.

### BRIEF DESCRIPTIONS OF THE DRAWINGS

FIG. 1 shows a block diagram of a signal processing chain for identifying sources of impairments

FIG. 2 illustrates the frequency response of an IF filter which may impair signals, and its form when frequency translated to baseband

FIG. 3 shows the characteristic of a filter for compensating the IF filter of FIG. 2

FIG. 4 illustrates a characteristic of an impaired signal processing chain in which the I and Q axes are not orthogonal

FIG. 5 shows the frequency response of an I or Q channel and the characteristic of a compensating filter

FIG. 6 shows the signal flow occurring for one sample value of a generalized filter

FIG. 7 shows an overall diagram of a generalized filter composed of individual FIR filters

### DETAILED DESCRIPTION OF THE INVENTION

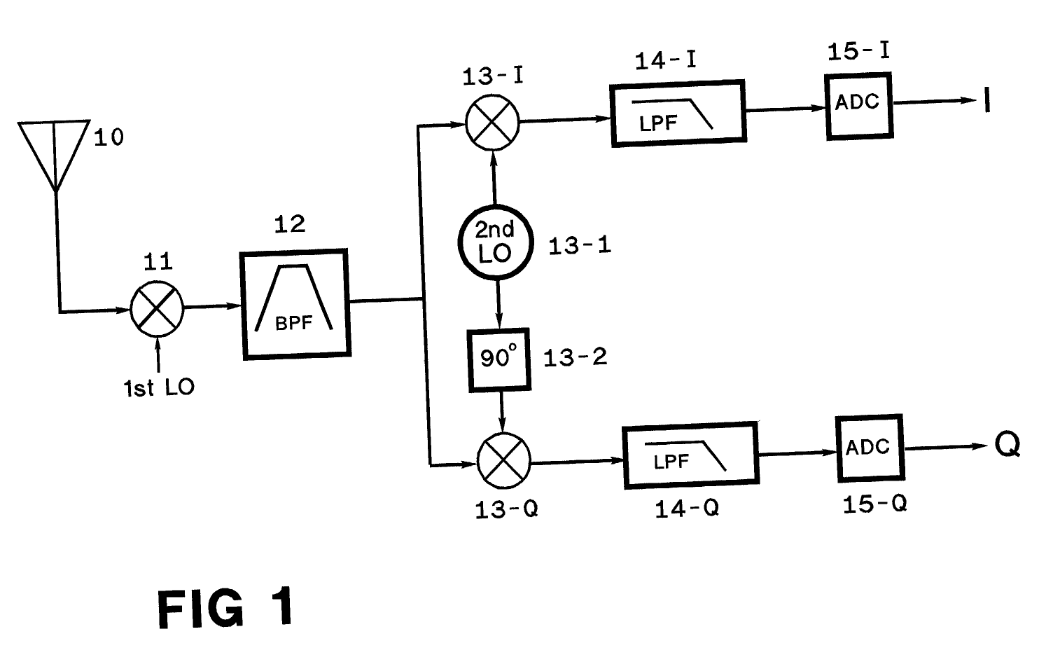

Refer now to FIG. 1 which shows a block diagram of the analog portion of a receiver such as those typically used in digital data communications. RF signals enter antenna 10 and, amplified by an RF amplifier (not shown), enter a first mixer 11. A first LO (local oscillator) drives mixer 11 and mixes with the RF signals. The frequency of the LO is chosen such that a desired RF signal, when frequency translated by the mixer, will be centered in the pass band of IF band pass filter 12. The output of band pass filter 12 is passed through an amplifier (not shown), then supplied to two mixers (that is, down-converters) 13-I and 13-Q. These mixers are the initial elements of two nominally identical processing channels I (in phase) and Q (quadrature). The original single component IF signal is thus converted into a two-component baseband signal, having been translated from the IF frequency emerging from filter 12. Mixers 13-I and 13-Q perform this translation and conversion. Mixer 13-I is driven by the 2^{nd} LO, and mixer 13-Q is driven by the same LO shifted 90° by phase shifter 13-2. Thus, the signal in the Q channel is nominally the same as that in the I channel, except that all its frequency components are shifted by 90°. This two-component I, Q signal is filtered in nominally identical low pass filters 14-I and 14-Q. If the remainder of the signal processing is to be digital, then the outputs of low pass filters 14-I and 14-Q are digitized by analog-to-digital converters 15-I and 15-Q, respectively.

FIG. 1 represents idealized signal processing. As was stated in the Background section and is well known to practitioners of this art, various impairments in the elements of this receiver limit dynamic range, distort modulation constellations, and cause other such problems. Several of the most common impairments amount to linear operations on the signal path and, as such, can be corrected by filters whose characteristics are inverse to those of the impairments. Such correction is particularly attractive in the case of digital processing of the baseband signals, since digital filters can be used. The advantages of digital filters include greater precision than analog filters, coefficients that can be changed to accommodate non-stationary impairment processes, and the ability to realize some transfer functions not possible with analog filters.

The specific embodiment of the invention described herein teaches how to correct three of the most common impairments, not with separate filters, as in the prior art, but in a single generalized filter operating on a two-component signal such as that shown. Correction for additional impairments could be added to the combined correction filter, provided they are essentially linear operations.

In order to illustrate how this is accomplished, each of the three impairments is explained and characterized below.

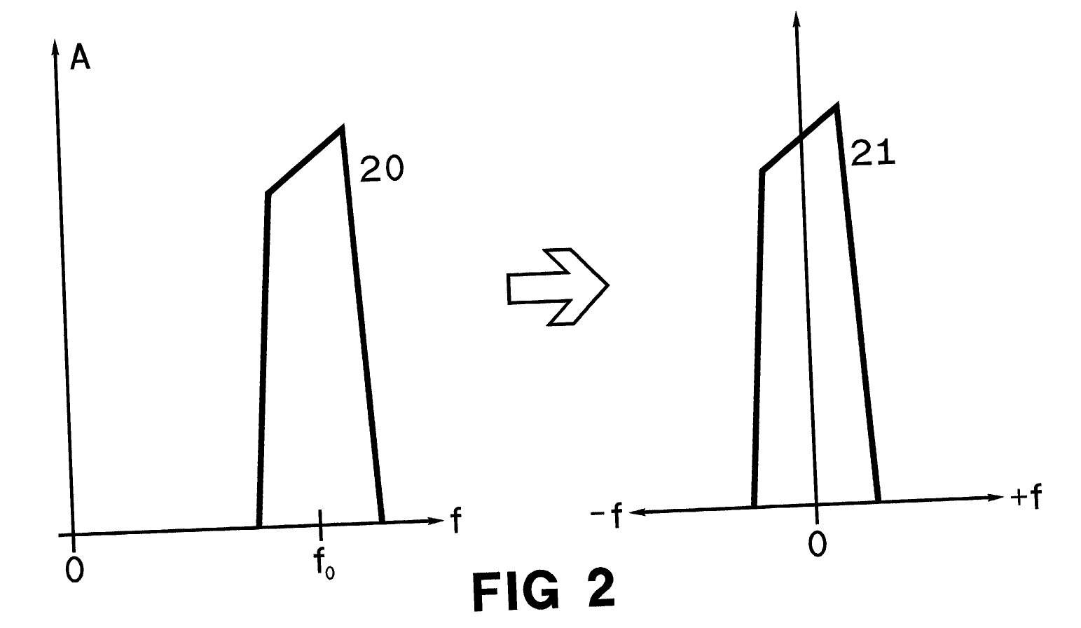

IF Bandpass Filter Error: FIG. 2 shows a simplified (straight line approximation) amplitude (A axis) vs. frequency response 20 of IF filter 12 centered on a center frequency f₀. The amplitude response is shown asymmetric, as might happen if a multipole filter were mistuned. Because of this, signals entering the IF filter will be compromised in passing through the filter. A common example is pure AM, which has even symmetry around the carrier. The lack of symmetry in the filter response will cause part of the sideband energy to be demodulated as a PM signal by the translation of the carrier to zero frequency (AM to PM conversion). The way to avoid such corruption is to pass the signals through filters which are symmetric, or—if this is not practical—to remove the corruption by additional, compensating filtering. This compensation can be conveniently applied at baseband, rather than at the IF, because of the linearity of the frequency translation. Hence, when the signals in the IF filter are translated to around zero frequency by mixers 13-4 and 13-Q (as indicated by the hollow arrow), in effect the filter response is also translated by a frequency shift from f₀ to zero. The amplitude response 21 around zero frequency is clearly not symmetric. In the time domain, this means that the impulse response is not real but complex.

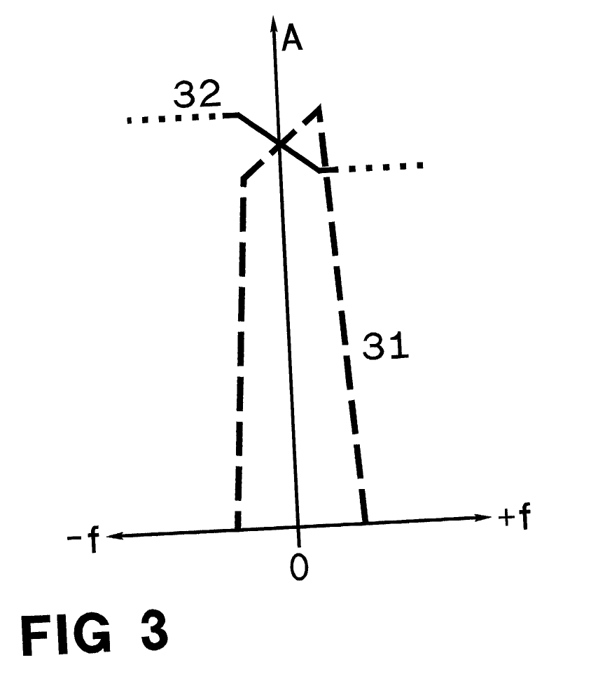

To restore the intrinsic symmetry of the baseband I and Q signal components, they can be passed through a two channel compensating baseband filter. The frequency response of this filter should complement that of the (translated) impaired filter, such that, when the frequency responses are multiplied, the result represents the desired symmetric characteristic. Such a filter would have an amplitude characteristic as indicated in FIG. 3. Previous asymmetric IF response 21 is shown dotted (31) for reference. The amplitude (A axis) characteristic of compensation filter 32 is shown in the passband, and for some distance in the transition bands. Beyond this, indicated by the dotted lines, the characteristics are unimportant and may be chosen to simplify the filter topography. (For simplicity, the phase characteristics have not been shown in these figures; the combination of the impaired and compensation filters should be conjugate symmetric in both amplitude and phase.)

Clearly, the compensation filter is also not symmetric, with the consequence that its time domain impulse response will also be complex, say hᵣ+jhᵢ, where the h's are each a series of n real numbers, assuming a FIR filter with n taps. In computing the response of such a filter in the time domain to a two-component input signal also considered as complex, the convolution requires a sequence of complex multiplications of the form (A+jB)(C+jD). In this case, for reasons that will soon be apparent, it is convenient to represent these calculations as a series of matrix multiplies:

$$[ \begin{matrix}A & - B \\ B & A\end{matrix} ] [ \begin{matrix}C \\ D\end{matrix} ]$$

Therefore, for the purpose of computing the effect of the compensation filter on the input signal, the filter's impulse response may be conveniently represented in the time domain by a set of n 2×2 matrices, each of the form

$$[ \begin{matrix}{h}_{r} & - {h}_{i} \\ {h}_{i} & {h}_{r}\end{matrix} ]$$

The output of the filter may be computed by convolving this matrix set with the input signal components S_{I} and S_{Q} represented as a 2×1 matrix.

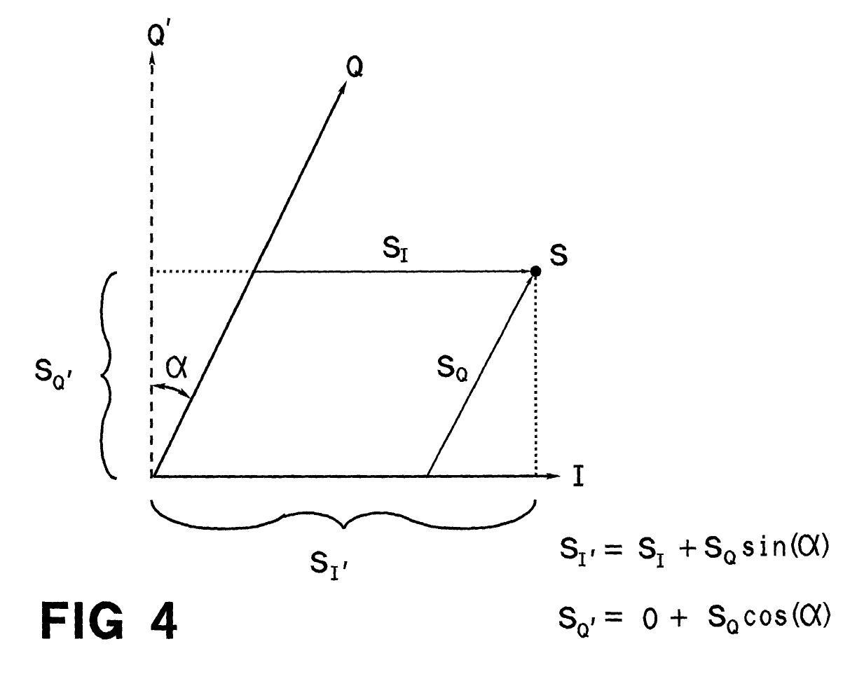

Quadrature error: In down-converter 13, it is possible that mixers 13-I and 13-Q are not driven exactly in phase quadrature by LO 13-1. This means that the resultant I and Q signals will not be orthogonal, and hence, not independent. FIG. 4 shows a diagram of the signal space defined by the I and Q axes. In this space, the Q axis deviates by an angle α from being in quadrature with the I axis. (In general, both I and Q axes may require realignment, but only a misaligned Q axis is shown here in order not to clutter the figure). A signal sample S is shown in the IQ space as a point S_{I}, S_{Q}. In order to rotate axis Q to the orthogonal position Q′ (while maintaining I′=I), the following transformation needs to be made:

S_{I′}=S_{I}+S_{Q} sin(α)

S_{Q′}=0+S_{Q} cos(α)

where S_{I′} and S_{Q′} are now the coordinates of the point S in the orthogonal {I′, Q′} space.

This operation can be cast in the form of a 2×2 matrix multiplying the two-component signal S:

$$[ \begin{matrix}{S}_{{I}^{′}} \\ {S}_{{Q}^{′}}\end{matrix} ] = [ \begin{matrix}1 & sin ( α ) \\ 0 & cos ( α )\end{matrix} ] [ \begin{matrix}{S}_{I} \\ {S}_{Q}\end{matrix} ]$$

Unlike the case of the filter above, there is only one matrix (n=1) which multiplies all the sample values of S. In general, when it is necessary to rotate both axes I and Q through different angles, this single matrix will have 4 non-zero, independent terms.

I, Q channel mismatch: The nominally identical I and Q channels will rarely actually be identical. Mixers 13, low pass filters 14, and ADCs 15 will likely differ in gain, and the frequency response of low pass filters 14 will not be flat and will differ from one another. These differences in gain can be compensated, and the frequency responses made flat in the desired passband, with the use of another two-channel filter.

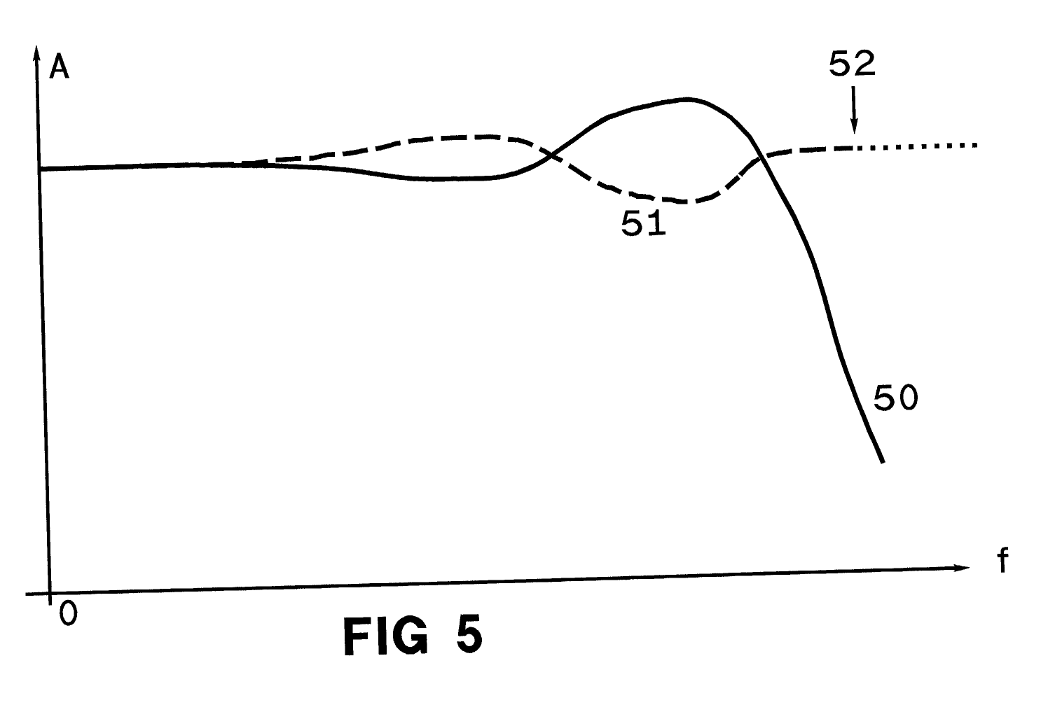

FIG. 5 shows a typical low pass amplitude (A axis) vs frequency response 50, and the response 51 of a possible compensating filter. (Again, only the amplitude response is shown for illustrative simplicity.) Beyond some point 52 in the transition band, the characteristics of the compensation filter become unimportant, and may be chosen for convenience or simplicity.

Since the signal in each channel is a real time function, the impulse response for each will also be real. Thus, to correct the impairments, a dual-channel filter would have one impulse response h_{I} for the I channel, and another h_{Q} for the Q channel. Again, it is convenient to express this filter as a set of 2×2 matrices:

$$[ \begin{matrix}{h}_{I} & 0 \\ 0 & {h}_{Q}\end{matrix} ]$$

These matrices are diagonal, since the I and Q branches are separate and independent and there are no cross terms.

Combining the correction of signal impairments: In the prior art, individual correction of the impairments described above has been accomplished with separate filter elements. In the invention disclosed herein, a single generalized two-channel filter simultaneously corrects all three forms of impairment. Particularly in hardware implementations of the present disclosure, there is considerable reduction of overall complexity, along with reduced latency, as the signal propagates through a shorter structure overall.

Because the impairment processes are linear, the corrections may be combined. At this point, it should be clear why the three correction operations are put into the form of 2×2 matrices. If individual correction filters were used, these would likely be concatenated and the signal would pass through each in turn. In this embodiment of the invention, a single generalized filter applies the three corrections simultaneously. To determine the characteristics of this filter, the combination of the three corrections may be computed by convolving their time domain characteristics.

If the impaired signal sequence is {x_{I}, x_{Q}}, and the corrected sequence is {y_{I}, y_{Q}}, the correction may be described in the time domain as

$$[ \begin{matrix}{y}_{I} \\ {y}_{Q}\end{matrix} ] = [ \begin{matrix}{h}_{r} & - {jh}_{i} \\ {jh}_{i} & {h}_{r}\end{matrix} ] * [ \begin{matrix}A & B \\ C & D\end{matrix} ] * [ \begin{matrix}{h}_{I} & 0 \\ 0 & {h}_{Q}\end{matrix} ] * [ \begin{matrix}{x}_{I} \\ {x}_{Q}\end{matrix} ] ,$$

where the asterisks represent convolution.

Because the second matrix on the right is not a sequence, but a single matrix, this expression may be simplified by replacing the first convolution with a matrix multiply:

$$[ \begin{matrix}{y}_{I} \\ {y}_{Q}\end{matrix} ] = [ \begin{matrix}{h}_{r} & - {jh}_{i} \\ {jh}_{i} & {h}_{r}\end{matrix} ] [ \begin{matrix}A & B \\ C & D\end{matrix} ] * [ \begin{matrix}{h}_{I} & 0 \\ 0 & {h}_{Q}\end{matrix} ] * [ \begin{matrix}{x}_{I} \\ {x}_{Q}\end{matrix} ]$$

Finally, by combining the three correction operations, the following compact form is obtained:

$$[ \begin{matrix}{y}_{I} \\ {y}_{Q}\end{matrix} ] = [ \begin{matrix}{h}_{11} & {h}_{12} \\ {h}_{21} & {h}_{22}\end{matrix} ] * [ \begin{matrix}{x}_{I} \\ {x}_{Q}\end{matrix} ]$$

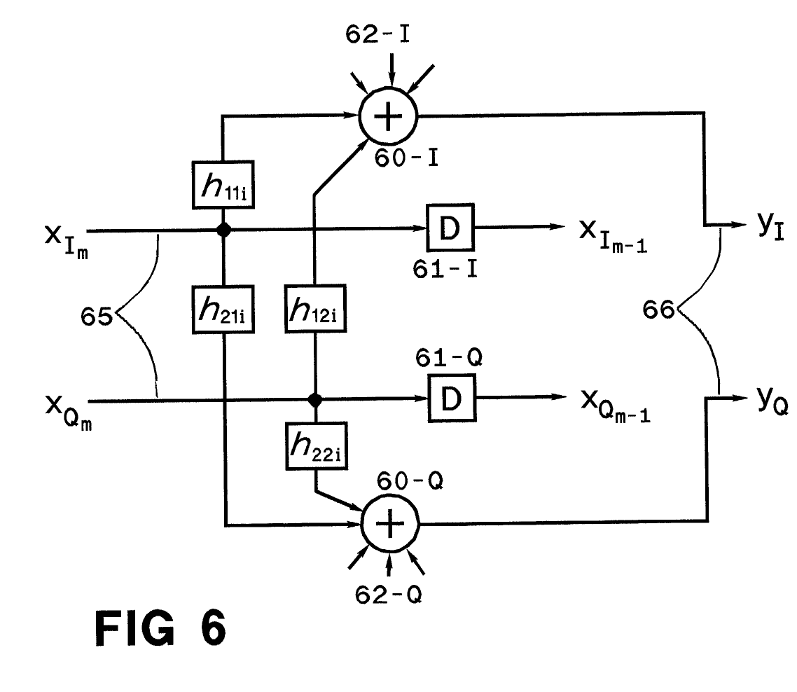

Here, the set of 2×2 matrices {h} represents a generalized filter for two-component signals. There are no constraints among the four elements of the matrix of a generalized filter. Unlike either the complex filter or the dual real filter, which have only two independent elements, the generalized filter has four. FIG. 6 shows the signal flow for the with stage of an generalized filter of length n. This is illustrated as a direct-form FIR filter, although other configurations may be used. The mth sample of the two-component (I and Q) signal x enters at input port 65, while the previous sample, the (m−1)th, emerges at the right from the unit delays 61, having already been processed in the ith stage of the filter. Each component of is multiplied by both a self- and a cross-impulse term, and the products are collected in the summing nodes 60, which are also collecting similar products from all the other stages of the filter. This is indicated by the plurality of arrows 62 shown connected to each summing node. The corrected output sequence y, also a signal with I and Q components, is available from the summing nodes comprising output port 66.

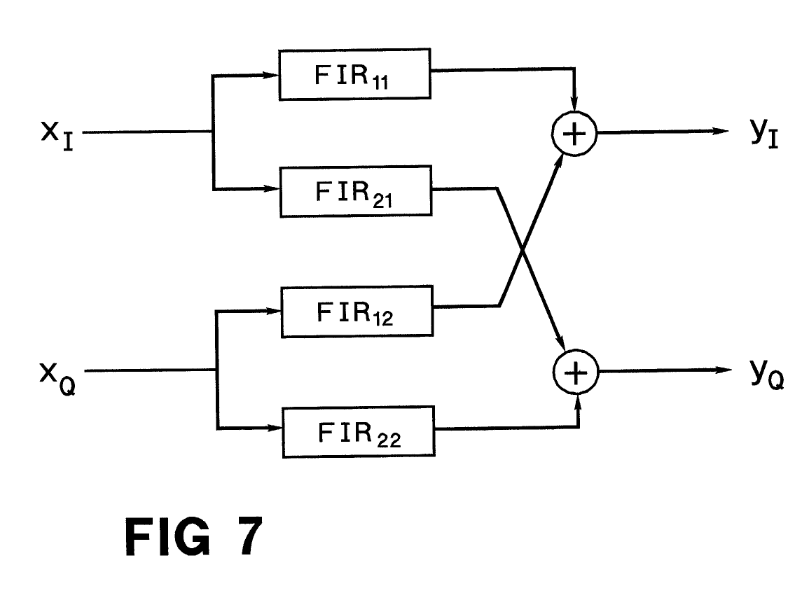

FIG. 7 shows the overall process in which the generalized filter is, in this embodiment, realized as four independent FIR filters coupled between input x and output y. These filters are characterized by the set of {h} matrices of the preceding paragraph.

Efficient computation for the generalized two-channel digital filter. The correlation computation represented symbolically above is the direct, time-domain operation of a generalized digital filter acting on a two-component signal x. For small impulse response lengths, along with modest speeds, the required number of multiply-accumulate operations needed per sample of the input signal can be handled with high speed, special purpose hardware. But longer impulse responses and higher speeds can represent a difficult challenge for this so-called direct form computation. For example, a general two-channel filter with an impulse response 256 samples long, running at 100 MHz—the kind often needed in data transmission operations—would require 1024 multiplies every 10 nanosecond period, a formidable hardware challenge.

In the prior art, it has been shown that, for the case of a one-component signal and a filter of either real or complex impulse response, the amount of computation can be reduced by using the time/frequency correspondence of convolution/multiplication, together with the Fast Fourier Transform. See, for instance, Oppenheim and Schafer, “Digital Signal Processing”, Prentice-Hall 1975, pages 110 ff. However, the present inventors know of no prior-art extension of this method to the generalized two-component signal case. In the present invention, such an extended method is disclosed, and the mathematical details may be found in the Appendix. The results of the extended method are incorporated in the following design procedure for implementing a generalized filter to simultaneously correct the impairments described previously. This procedure is applicable to processing a continuous flow of input signal by operating on contiguous blocks of length N/2 samples of the input signal. The corrected output is produced in blocks of length N/2, which, when concatenated using appropriate buffering, become a continuous output signal flow.

Design procedure for compensating signal impairments by using a generalized filter. This procedure assumes the need for compensating the elements of the embodiment of FIG. 1: IF filter 12, quadrature mixers 13-I and 13-Q, and lowpass filters 14-I and 14-Q. However, the procedure is applicable to any number of concatenated elements in the signal path, provided that the impairments imposed by each element are linear in nature.

Initializing steps:

1. Choose a length N/2 for the finite impulse response of the correction filter, where N is an integer power of 2.

2. Characterize each filter element in the frequency domain, and determine the appropriate compensation in that domain which would satisfactorily correct the filter impairment. Use the Discrete Fourier Transform to convert the compensation characteristic for each filter into an impulse response sequence of N/2 samples. Form each impulse response into a sequence of 2×2 matrices, as previously illustrated.

3. Determine the quadrature error in the mixers and the multiplier factors needed to restore quadrature. Put these into the form of a 2×2 matrix, as previously illustrated.

4. Combine these matrix sequences into a single matrix sequence hₙ by convolution:

$${h}_{n} = [ \begin{matrix}{h}_{11 n} & {h}_{12 n} \\ {h}_{21 n} & {h}_{22 n}\end{matrix} ] , 0 \leq n < N / 2$$

5. Form the complex vectors

$${a}_{n} = \frac{( {h}_{11 n} + {h}_{22 n} ) + j ( {h}_{21 n} - {h}_{12 n} )}{2} and {b}_{n} = \frac{( {h}_{11 n} - {h}_{22 n} ) + j ( {h}_{21 n} + {h}_{12 n} )}{2}$$

6. Append N/2 zeros to the end of aₙ and bₙ to make each of these complex vectors contain N entries.

7. Perform an N-point complex FFT on aₙ and bₙ to get Aₖ and Bₖ respectively.

The previous steps are preliminary and are not repeated unless the analog hardware (steps 1-4) and/or filter specifications (steps 5-7) change. The following steps are repeated for each new block of N/2 input samples, usually regarded as part of a continuous stream of data. These samples are contained in a vector xₙ of length N.

8. Transfer the second half of the previous input vector into the first half:

$$[ \begin{matrix}{x}_{In} \\ {x}_{Qn}\end{matrix} ] = [ \begin{matrix}{x}_{I ( n + N / 2 )} \\ {x}_{Q ( n + N / 2 )}\end{matrix} ] , 0 \leq n < N / 2$$

9. Load N/2 new data points into the second half of the input vector xₙ

10. Treating xₙ as a vector of complex numbers x_{In}+jx_{Qn}, perform an N-point complex FFT to get Xₖ.

11. Compute the complex vector Yₖ=AₖXₖ+BₖX_{N-k}, 0≦k<N, using the complex vectors Aₖ and Bₖ computed in step 7.

12. Perform an inverse N-point complex FFT on Yₖ to get the complex vector yₙ.

13. Use the second half of yₙ as the N/2 output samples from this iteration of the computation:

$$[ \begin{matrix}{y}_{In} \\ {y}_{Qn}\end{matrix} ] = [ \begin{matrix}Re ( {y}_{n + N / 2} ) \\ Im ( {y}_{n + N / 2} )\end{matrix} ] , 0 \leq n < N / 2$$

14. Return to step 8 for the next N/2 data points.

The following appendix includes mathematical details concerning the efficient calculation of the response of the generalized filter to an arbitrary signal.

### Appendix

A generalized linear processing block for sampled I, Q signals can be described as follows. Assume a sampled input sequence xₙ where each sample consists of a two element vector representing the I and Q input channels. Similarly yₙ is the output sequence, where each sample is a two element vector representing the I and Q output channels.

$${y}_{n} = [ \begin{matrix}{y}_{1 n} \\ {y}_{2 n}\end{matrix} ]$$

$${x}_{n} = [ \begin{matrix}{x}_{1 n} \\ {x}_{2 n}\end{matrix} ]$$

The most general linear system relates the input and output sequences by the convolution

yₙ=hₙ\mathring{x}xₙ

where h, is a sequence of 2×2 matrices which characterize the impulse response of the system.

$${h}_{n} = [ \begin{matrix}{h}_{11 n} & {h}_{12 n} \\ {h}_{21 n} & {h}_{22 n}\end{matrix} ]$$

The h₁₁ₙ sequence is the impulse response from the input I channel to the output I channel. The h₁₂ₙ sequence is the impulse response from the input Q channel to the output I channel. The remaining two sequences are the Q channel impulse responses from the I and Q channel inputs. Note that this representation is more general than a complex coefficient filter, since a complex coefficient filter has the constraint that h₁₁ₙ=h₂₂ₙ and h₁₂ₙ=−h₂₁ₙ. Note also that the general representation also covers the case where the I and Q channels are filtered with independent real coefficient filters. This case has the constraint that h₁₂ₙ=h₂₁ₙ=0.

To make the filter computable, apply the practical constraint that the impulse response sequence is non-zero only for a finite duration of N/2 samples from when the impulse is applied. Thus, the convolution can be written with the following summation. For the subsequent analysis N is restricted to be an integer power of 2.

$${y}_{n} = {h}_{n} ⊗ {x}_{n} = {\sum }_{m = 0}^{N / 2 - 1} {h}_{m} {x}_{n - m} , - ∞ < n < ∞$$

An efficient method of computing the summation can be obtained by using FFT techniques. In order to cast the problem in this form, the input sequence and impulse response is first restated in terms of periodic sequences as follows.

$${h}_{m}^{′} = \{ \begin{matrix}{h}_{m mod N} , 0 \leq m mod N < N / 2 \\ 0 , otherwise\end{matrix} \\ {x}_{n}^{′} = {x}_{n mod N}$$

The output sequence can now be defined as

$${y}_{n}^{′} = {\sum }_{m = 0}^{N - 1} {h}_{m}^{′} {x}_{n - m}^{′}$$

An examination of the periodic output sequence, y′ₙ and the desired output sequence, yₙ shows that they are equal over a portion of the sequence.

y′ₙ=yₙ, N/2≦n<N

Subsequent summations using input blocks indexed from a different starting sample can be used to obtain the complete output sequence. For each N/2 samples out, the input sequence index is advanced by N/2 samples. In the following analysis it is useful to decompose the impulse response matrix as follows.

$${h}_{n} = {a}_{n} + {b}_{n}$$

$$where$$

$${a}_{n} = [ \begin{matrix}{a}_{1 n} & - {a}_{2 n} \\ {a}_{2 n} & {a}_{1 n}\end{matrix} ]$$

$${b}_{n} = [ \begin{matrix}{b}_{1 n} & {b}_{2 n} \\ {b}_{2 n} & - {b}_{1 n}\end{matrix} ]$$

The significance of this decomposition is that matrices of ‘type a’ are equivalent to a complex multiplication by a₁ₙ+ja₂ₙ, if the input is interpreted as a complex number x₁+jx₂. The ‘type b’ matrices represent that portion of the general impulse response which cannot be represented as a complex multiplication. There are several useful facts about these matrices which can be exploited. Before stating these properties, first define the conjugate of a matrix as follows.

Given the matrix

$$M = [ \begin{matrix}w & x \\ y & z\end{matrix} ]$$

define the ‘conjugate’ of M as,

$${M}^{*} = [ \begin{matrix}w & - x \\ - y & z\end{matrix} ] .$$

With this definition the following statements hold for all ‘type a’ matrices A₁, A₂ and for all ‘type b’ matrices B_{1l , B}₂.

A₁A₂=A₂A₁=type a

B₁B₂=(B₂B₁)*=type a

A₁B₁=B₁A*₁=type b

B₁A₁=A*₁B₁=type b

Using this decomposition, the periodic output sequence can now be written as

$${y}_{n}^{′} = {\sum }_{m = 0}^{N - 1} {a}_{m}^{′} {x}_{n - m}^{′} + {\sum }_{m = 0}^{N - 1} {b}_{m}^{′} {x}_{n - m}^{′}$$

The first of the two summations can be written as,

$${y}_{an}^{′} = {\sum }_{m = 0}^{N - 1} {a}_{m}^{′} {x}_{n - m}^{′} = {\sum }_{r = 0}^{N - 1} δ ( n - r ) {\sum }_{m = 0}^{N - 1} {a}_{m}^{′} {x}_{r - m}^{′}$$

where δ is the delta or impulse function, which is unity only when n=r, and is zero otherwise. Over the range of n and r of interest (N/2≦n<N, 0≦n<N), the delta function can be replaced by the periodic delta function as represented by the summation in the following equation.

$${y}_{an}^{′} = {\sum }_{r = 0}^{N - 1} \frac{1}{N} {\sum }_{k = 0}^{N - 1} {W}_{N}^{k ( n - r )} {\sum }_{m = 0}^{N - 1} {a}_{m}^{′} {x}_{r - m}^{′}$$

$$Where , \\ {W}_{N}^{k} = [ \begin{matrix}cos ( 2 π k / N ) & - sin ( 2 π k / N ) \\ sin ( 2 π k / N ) & cos ( 2 π k / N )\end{matrix} ]$$

The W matrices are ‘type a’ and represent a rotation in the I Q plane through an angle of 2πk/N. Since cascaded rotations are equivalent to a single rotation of the sum of angles, the following statement is true in general for rotation matrices.

W_{N}^{k}W_{N}ⁿ=W_{N}^{k+n}=W_{N}ⁿW_{N}^{k}

These properties can be used to rewrite the previous summation. Note that the order of the summations has been changed.

$${y}_{an}^{′} = \frac{1}{N} {\sum }_{k = 0}^{N - 1} {W}_{N}^{kn} {\sum }_{m = 0}^{N - 1} {W}_{N}^{- k m} {a}_{m}^{′} {\sum }_{r = 0}^{N - 1} {W}_{N}^{- k ( r - m )} {x}_{r - m}^{′}$$

The W_{N}^{-k(r-m)} factor commuted with a′ₘ because both were ‘type a’ matrices. This will not be the case when the summation involving b′ₘ is examined. In the final summation the substitution p=r−m can be made. Then, using the fact that both W_{N}^{-kp} and x′ₚ are periodic over the summation interval, the starting point of the summation is arbitrary. Thus, the sum can be rewritten as follows.

$${y}_{an}^{′} = \frac{1}{N} {\sum }_{k = 0}^{N - 1} {W}_{N}^{kn} {\sum }_{m = 0}^{N - 1} {W}_{N}^{- k m} {a}_{m}^{′} {\sum }_{r = 0}^{N - 1} {W}_{N}^{- kr} {x}_{r}^{′}$$

Now introduce the following notation for the second and third summations.

$${A}_{k} = {\sum }_{m = 0}^{N - 1} {W}_{N}^{- k m} {a}_{m}^{′}$$

$${X}_{k} = {\sum }_{r = 0}^{N - 1} {W}_{N}^{- k r} {x}_{r}^{′}$$

Aₖ is a type ‘a’ matrix, and Xₖ is a vector. Using this notation gives the following result.

$${y}_{an}^{′} = \frac{1}{N} {\sum }_{k = 0}^{N - 1} {W}_{N}^{kn} ( {A}_{k} \cdot {X}_{k} )$$

The same analysis can be done for the term in the periodic output sequence involving b′ₘ. The only difference is that rearranging the multiplication with a type ‘b’ matrix requires that the rotation matrix be conjugated. This is equivalent to replacing the index k with −k. The final result for the total periodic output can then be written as follows.

$${y}_{n}^{′} = \frac{1}{N} {\sum }_{k = 0}^{N - 1} {W}_{N}^{kn} ( {A}_{k} {X}_{k} + {B}_{k} {X}_{N - k} )$$

The computation of Aₖ can be cast exactly into the form of a complex discrete Fourier transform by forming a complex scalar equation.

$${A}_{1 k} + {jA}_{2 k} = [ 1 j ] [ {\sum }_{m = 0}^{N - 1} {W}_{N}^{- k m} {a}_{m}^{′} ] [ \begin{matrix}1 \\ 0\end{matrix} ] = {\sum }_{m = 0}^{N - 1} {ⅇ}^{- 2 π j k m / N} ( {a}_{1 m}^{′} + {ja}_{2 m}^{′} ) = {F}_{N} \{ {a}_{1 m}^{′} + {ja}_{2 m}^{′} \}$$

Where the operator F_{N} denotes the N-point discreet Fourier transform of a complex sequence. The resulting Aₖ matrix can be written in terms of the real and imaginary parts of the transformed sequence.

$${A}_{k} = [ \begin{matrix}{A}_{1 k} & - {A}_{2 k} \\ {A}_{2 k} & {A}_{1 k}\end{matrix} ]$$

Similarly, given the Fourier transform,

B₁ₖ+jB₂ₖ=F_{N}{b′₁ₘ+jb′₂ₘ}

the Bₖ matrix is,

$${B}_{k} = [ \begin{matrix}{B}_{1 k} & {B}_{2 k} \\ {B}_{2 k} & - {B}_{1 k}\end{matrix} ]$$

Lastly, the Xₖ vector can be computed with the following Fourier transform.

X₁ₖ+jX₂ₖ=F_{N}{x′₁ₘ+jx′₂ₘ}

$${X}_{k} = [ \begin{matrix}{X}_{1 k} \\ {X}_{2 k}\end{matrix} ]$$

In the case that a′ₖ is diagonal for all k, the Fourier transform has conjugate symmetry so that

A_{N-k}=A*ₖ

Similarly, if b′ₙ is diagonal for all n, the Bₖ matrix has symmetry.

B_{N-k}=B*ₖ

These symmetries can be exploited to require less coefficient storage when the impulse response matrix sequence is known to contain only diagonal matrices.

From the foregoing, it will be recognized that the detailed embodiment is illustrative only, and should not be taken as limiting the scope of our invention. For example, although the embodiment disclosed a receiver as a platform for practicing the principles of the invention, such principles would readily apply to the generation of a modulated signal, beginning with the data to be transmitted. In this case, a generalized filter could be constructed to predistort the data signals in such a way as to compensate impairments occurring later in the processing paths. Likewise, many other forms of linear impairments other than those exemplified may be compensated through practicing the principles of the invention. An example of such impairments is multipath transmission. Therefore, we claim as our invention all such variations as may fall within the scope and spirit of the following claims and equivalents thereto.

What is claimed is:

1. In an information transmission system comprising a plurality of elements for generating, transporting, and receiving information, wherein some elements are defective and impose impairments on the information passing therethrough, a method for correcting said impairments, comprising the steps of:
a) identifying defective elements and characterizing the defect of each;
b) determining a correction characteristic corresponding to each defective element which, when applied to information passing through said element, corrects the impairment imposed by said element;
c) formulating each correction characteristic as a composite, two channel I and Q finite impulse response, having I-I and Q-Q direct components and I-Q and Q-I cross components;
d) combining said correction characteristics of said defective elements into a single correction characteristic comprising two direct and two cross components;
e) identifying each of the four components of the combined correction characteristics with corresponding direct and cross impulse responses of a generalized two-channel filter;
f) creating such a filter in accordance with said components of step (e); and
g) positioning said filter in said information transmission system for correcting said impairments imposed on the information by said defective elements.

2. An information transmission system, as in claim 1, wherein said system is limited to a data receiver whose elements include an IF filter, a two-channel down-converter, and I and Q data processing channels.

3. An information transmission system, as in claim 1, wherein said system is limited to a data generator whose elements include I and Q data channels, a two-channel up-converting modulator, and an IF filter.

4. An information transmission system, as in claim 1, wherein:
i. step (a) further includes performing a frequency analysis of each defective element;
ii. step (b) further includes creating a frequency characteristic complementary to said frequency analysis of step (i) such that the combination of said analysis and said complementary characteristic removes the impairment caused by said defective element; and
iii. step (c) further includes performing an inverse discrete Fourier transform of said complementary characteristic.

5. An information transmission system, as in claim 1, wherein:
i. step (c) further includes arranging said direct and said cross components as terms of a set of 2×2 matrices; and
ii. step (d) further includes arranging said single correction characteristic as terms of a set of 2×2 matrices.

6. A generalized digital filter for filtering two-component signal information, comprising:
a) a dual input port, having an I input for a signal x_{I} and a Q input for a signal x_{Q}, wherein x_{I} and x_{Q} are components of a two-component input signal x;
b) a dual output port, having an I output for a signal y_{I} and a Q output for a signal y_{Q}, wherein y_{I} and y_{Q} are components of a two-component output signal y;
c) a first signal path, characterized by a first impulse response, having an input coupled to the I input port and a first output;
d) a second signal path, characterized by a second impulse response, having an input coupled to the Q input port and a second output;
e) a third signal path, characterized by a third impulse response, having an input coupled to the I input port and a third output;
f) a fourth signal path, characterized by a fourth impulse response, having an input coupled to the Q input port and a fourth output;
g) summing means for adding said first and second outputs and for coupling the sum thereof to said I output;
h) summing means for adding said third and fourth outputs and for coupling the sum thereof to said Q output.

7. A generalized digital filter, as in claim 6, wherein said first, second, third, and fourth impulse responses are independent of one another.

8. A generalized digital filter, as in claim 7, wherein said first, second, third, and fourth impulse responses are further constrained to have finite lengths.

9. A generalized digital filter, as in claim 8, wherein said first, second, third, and fourth impulse responses are further constrained to have equal lengths.

10. A generalized digital filter, as in claim 6, wherein said first, second, third, and fourth signal paths are realized by finite impulse-response filters.

11. A generalized digital filter, as in claim 10, wherein each of said finite impulse-response filters is independently characterized.

12. In applying a generalized two-channel digital filter to process an input data stream x and to produce an output data stream y, wherein both x and y are two-component signals x_{I}, x_{Q}, y_{I}, and y_{Q} which are processed in blocks of N/2 data values long, N being a power of 2, and wherein the filter is characterized by four independent impulse response vectors h₁₁, h₁₂, h₂₁, and h₂₂, each vector of length N/2, a method for efficiently computing said output data stream y, comprising the preliminary steps of.
a) forming the vectors
$$a = \frac{( {h}_{11} + {h}_{22} ) + j ( {h}_{21} - {h}_{12} )}{2} and b = \frac{( {h}_{11} - {h}_{22} ) + j ( {h}_{21} + {h}_{12} )}{2}$$
b) appending N/2 zeros to each vector and performing an FFT on each vector to produce Aₖ and Bₖ, respectively;
and, for each block of N/2 data values in said input data stream x, additionally comprising the iterative steps of:
c) moving the previous block of input data values to the first half of an input vector x_{N} of length N and loading the current block of input data values into the second half of said input vector x_{N};
d) treating x_{N} as a vector of complex numbers of the form x_{I}+jx_{Q}, and performing a N-point FFT to produce Xₖ;
e) computing the complex vector Yₖ=AₖXₖ+BₖX_{N-k}, 0≦k<N/2, and performing an inverse FFT on the result to produce the complex vector yₙ;
f) designating the second half of yₙ as the N/2 output samples of the current iteration, according to y_{In}=Real (y_{Q}), yₙ=Imag (yₙ), where N/2≦n<N; and
g) returning to step (c) for the next N/2 data values.
